(19) United States
(12) Patent Application Publication
(10) Pub. No.: US 2026/0367830 A1
(43) Pub. Date: Nov. 19, 2026

(54) DATA LOG STORAGE AND MANAGEMENT USING MEMORY SUB-SYSTEM CONTROLLER MEMORY BUFFER

(71) Applicant: MICRON TECHNOLOGY, INC., Boise, ID (US)

(72) Inventors: Liang Tang, Shanghai (CN); Guang Shen, Shanghai (CN)

(21) Appl. No.: 19/209,174

(22) Filed: May 15, 2025

(51) Int. Cl. G06F 3/06

(52) U.S. Cl. CPC G06F 3/0656; G06F 3/061; G06F 3/0679

(57) ABSTRACT

A processing device in a memory sub-system identifies a first set of input/output (I/O) data logs associated with a non-volatile memory device of the memory sub-system. The processing device writes the first set of I/O data logs to a first set of memory buffer blocks of the controller memory buffer, where the controller memory buffer is accessible via an interface (e.g., accessible by host system to read the first set of I/O data logs).

### TECHNICAL FIELD

Embodiments of the disclosure relate generally to memory sub-systems, and more specifically, relate to storing and managing data logs using a memory sub-system controller memory buffer.

### BACKGROUND

A memory sub-system can include one or more memory devices that store data. The memory devices can be, for example, non-volatile memory devices and volatile memory devices. In general, a host system can utilize a memory sub-system to store data at the memory devices and to retrieve data from the memory devices.

### BRIEF DESCRIPTION OF THE DRAWINGS

The present disclosure will be understood more fully from the detailed description given below and from the accompanying drawings of various embodiments of the disclosure.

FIG. 1 illustrates an example computing system that includes a memory sub-system in accordance with some embodiments of the present disclosure.

FIG. 2 illustrates an example memory sub-system including a log manager to manage recording of data logs to a memory sub-system controller memory buffer accessible by a computing system for data log retrieval, in accordance with one or more embodiments of the present disclosure.

FIG. 3 is a flow diagram of an example method of recording data logs using a memory sub-system controller memory buffer, in accordance with one or more embodiments of the present disclosure.

FIG. 4 is a flow diagram of an example of a computing system (e.g., a debug computing system) accessing a memory sub-system controller memory buffer to read data logs for use in executing a debugging process, in accordance with some embodiments of the present disclosure.

FIG. 5 is a block diagram of an example computer system in which embodiments of the present disclosure may operate.

### DETAILED DESCRIPTION

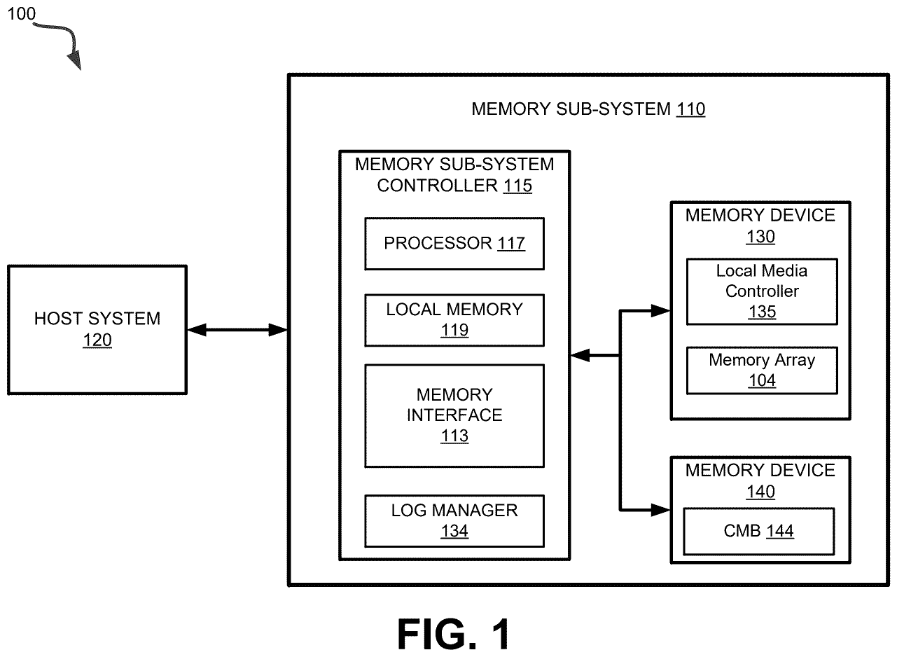

Aspects of the present disclosure are directed to managing log data (e.g., input/output (I/O) logs) using a memory sub-system controller memory buffer. A memory sub-system can be a storage device, a memory module, or a hybrid of a storage device and memory module. Examples of storage devices and memory modules are described below in conjunction with FIG. 1. In general, a host system can utilize a memory sub-system that includes one or more components, such as memory devices that store data. The host system can provide data to be stored at the memory sub-system and can request data to be retrieved from the memory sub-system.

A memory sub-system can include high density non-volatile memory devices where retention of data is desired when no power is supplied to the memory device. For example, NAND memory, such as 3D flash NAND memory, offers storage in the form of compact, high density configurations. A non-volatile memory device is a package of one or more dice, each including one or more planes. For some types of non-volatile memory devices (e.g., NAND memory), each plane includes of a set of physical blocks. Each block includes of a set of pages. Each page includes of a set of memory cells (“cells”). A cell is an electronic circuit that stores information. Depending on the cell type, a cell can store one or more bits of binary information, and has various logic states that correlate to the number of bits being stored. The logic states can be represented by binary values, such as “0” and “1”, or combinations of such values.

A memory device can be made up of bits arranged in a two-dimensional or a three-dimensional grid. Memory cells are formed onto a silicon wafer in an array of columns (also hereinafter referred to as bitlines) and rows (also hereinafter referred to as wordlines). A wordline can refer to one or more rows of memory cells of a memory device that are used with one or more bitlines to generate the address of each of the memory cells. The intersection of a bitline and wordline constitutes the address of the memory cell. A block hereinafter refers to a unit of the memory device used to store data and can include a group of memory cells, a wordline group, a wordline, or individual memory cells. One or more blocks can be grouped together to form separate partitions (e.g., planes) of the memory device in order to allow concurrent operations to take place on each plane.

One example of a memory sub-system is a solid-state drive (SSD) that includes one or more non-volatile memory devices and a memory sub-system controller to manage the non-volatile memory devices. In some implementations, memory sub-systems can include firmware that is subject to debugging processes to identify input/output (I/O)-related issues. Debugging I/O issues in the memory sub-system can involve identifying and resolving problems that affect data transfer between one or more memory devices of the memory sub-system and a host system. These issues can arise from various factors, including firmware bugs, memory device degradation, power surges, or overheating.

Debugging tools may be employed (e.g., crash dumps, JTAG debugging, event tracking, etc.) to identify the root cause of failures. The debugging process often relies on the use of I/O data logs that are recorded and stored. The I/O data logs are typically recorded and stored along with other firmware-related logs. However, the number of I/O data logs (and corresponding amount of I/O data) saved by the memory sub-system is limited. For example, a log file spanning 10 seconds of activity may include 60 million log entries, without only approximately 100 I/O data log entries in the log file.

Some systems save data logs to the host system using a high-speed interface. However, this approach requires the use of additional hardware (the high-speed interface) and hardware support, which limits accessibility of the I/O data for debugging purposes when the memory sub-system is deployed at a customer location. Other systems write firmware logs directly to one or more memory devices of the memory sub-system. In such systems, the log data is read from the memory device(s) when needed to perform debugging operations. However, due to memory device utilization requirements and available storage restrictions, this approach allows only a small number of I/O data logs. Furthermore, this approach limits the ability to access the I/O data logs of a memory sub-system deployed in a production (i.e., runtime) environment.

Aspects of the present disclosure address the above and other deficiencies by using a memory sub-system controller memory buffer (CMB) of a memory sub-system to store I/O log data for use in a subsequent debugging operation. According to embodiments, the memory sub-system controller memory buffer (CMB) is directly accessible by a host system (e.g., a server) configured to execute a debugging process. According to embodiments, the host system (herein referred to as the “debug computing system”) can access the I/O data logs stored in the memory sub-system controller memory buffer (CMB) via an interface (e.g., a PCEi interface). The I/O data logs can be retrieved by the debug computing system from the memory sub-system controller memory buffer (CMB) for use in the execution of one or more debug processes.

According to embodiments, the memory sub-system controller including control logic to execute a log recording process including writing I/O data logs (e.g., I/O operation logs including data associated with I/O activities) to the memory sub-system controller memory buffer (CMB). In an embodiment, the memory sub-system controller memory buffer (CMB) includes a set of blocks (e.g., high-speed storage areas), where each block (also referred to as a “CMB block”) is configured to store a segment or portion of the I/O data. In an embodiment, each CMB block is designated or allocated for storing I/O data logs for a threshold period of time before the CMB block can be overwritten.

According to embodiments, the memory sub-system controller can determine that a CMB block has been read by the debug computing system, indicating that this CMB block can be rewritten with new I/O log data by the memory sub-system controller.

According to embodiments, an I/O data log can be written to the memory sub-system controller memory buffer (CMB) at a first time, and read from the memory sub-system controller memory buffer (CMB) by the debug computing system at a short interval following the first time. In this regard, “real-time” recording and “real-time” reading of the I/O log data can be achieved.

Advantages of the approach described herein include, but are not limited to, efficient I/O data log recording. In addition, the stored I/O data logs can be more efficiently accessed by a computing system for purposes of using the I/O data to perform I/O debugging operations. In addition, storage in the memory sub-system controller memory buffer can be cyclically refreshed and optimized. In this regard, an I/O data log can be written to a block of the memory sub-system controller memory buffer by control logic of the memory sub-system controller, and a short interval after can be accessed and retrieved by a secondary computing system (e.g., a computing system configured to perform one or more debugging processes). The reading of the I/O data log enables the capturing the I/O data stored in the I/O data log for use in executing a debugging process, and further frees up the block of the memory sub-system controller memory buffer to be overwritten with an additional or new I/O data log.

FIG. 1 illustrates an example computing system 100 that includes a memory sub-system 110 in accordance with some embodiments of the present disclosure. The memory sub-system 110 can include media, such as one or more volatile memory devices (e.g., memory device 140), one or more non-volatile memory devices (e.g., one or more memory device(s) 130), or a combination of such.

A memory sub-system 110 can be a storage device, a memory module, or a hybrid of a storage device and memory module. Examples of a storage device include a solid-state drive (SSD), a flash drive, a universal serial bus (USB) flash drive, an embedded Multi-Media Controller (eMMC) drive, a Universal Flash Storage (UFS) drive, a secure digital (SD) card, and a hard disk drive (HDD). Examples of memory modules include a dual in-line memory module (DIMM), a small outline DIMM (SO-DIMM), and various types of non-volatile dual in-line memory modules (NVDIMMs).

The computing system 100 can be a computing device such as a desktop computer, laptop computer, network server, mobile device, a vehicle (e.g., airplane, drone, train, automobile, or other conveyance), Internet of Things (IOT) enabled device, embedded computer (e.g., one included in a vehicle, industrial equipment, or a networked commercial device), or such computing device that includes memory and a processing device.

The computing system 100 can include a host system 120 that is coupled to one or more memory sub-systems 110. In some embodiments, the host system 120 is coupled to different types of memory sub-system 110. FIG. 1 illustrates one example of a host system 120 coupled to one memory sub-system 110. As used herein, “coupled to” or “coupled with” generally refers to a connection between components, which can be an indirect communicative connection or direct communicative connection (e.g., without intervening components), whether wired or wireless, including connections such as electrical, optical, magnetic, etc.

The host system 120 can include a processor chipset and a software stack executed by the processor chipset. The processor chipset can include one or more cores, one or more caches, a memory controller (e.g., NVDIMM controller), and a storage protocol controller (e.g., PCIe controller, SATA controller, CXL controller). The host system 120 uses the memory sub-system 110, for example, to write data to the memory sub-system 110 and read data from the memory sub-system 110.

The host system 120 can be coupled to the memory sub-system 110 via a physical host interface. Examples of a physical host interface include, but are not limited to, a serial advanced technology attachment (SATA) interface, a compute express link (CXL) interface, a peripheral component interconnect express (PCIe) interface, universal serial bus (USB) interface, Fibre Channel, Serial Attached SCSI (SAS), a double data rate (DDR) memory bus, Small Computer System Interface (SCSI), a dual in-line memory module (DIMM) interface (e.g., DIMM socket interface that supports Double Data Rate (DDR)), etc. The physical host interface can be used to transmit data between the host system 120 and the memory sub-system 110. The host system 120 can further utilize an NVM Express (NVMe) interface to access the memory components (e.g., the one or more memory device(s) 130) when the memory sub-system 110 is coupled with the host system 120 by the physical host interface (e.g., PCIe or CXL bus). The physical host interface can provide an interface for passing control, address, data, and other signals between the memory sub-system 110 and the host system 120. FIG. 1 illustrates a memory sub-system 110 as an example. In general, the host system 120 can access multiple memory sub-systems via a same communication connection, multiple separate communication connections, and/or a combination of communication connections.

The memory devices 130, 140 can include any combination of the different types of non-volatile memory devices and/or volatile memory devices. The volatile memory devices (e.g., memory device 140) can be, but are not limited to, random access memory (RAM), such as dynamic random access memory (DRAM) and synchronous dynamic random access memory (SDRAM).

Some examples of non-volatile memory devices (e.g., memory device(s) 130) include negative-and (NAND) type flash memory and write-in-place memory, such as three-dimensional cross-point (“3D cross-point”) memory. A cross-point array of non-volatile memory can perform bit storage based on a change of bulk resistance, in conjunction with a stackable cross-gridded data access array. Additionally, in contrast to many flash-based memories, cross-point non-volatile memory can perform a write in-place operation, where a non-volatile memory cell can be programmed without the non-volatile memory cell being previously erased. NAND type flash memory includes, for example, two-dimensional NAND (2D NAND) and three-dimensional NAND (3D NAND).

Each of the memory device(s) 130 can include one or more arrays of memory cells. One type of memory cell, for example, single level cells (SLC) can store one bit per cell. Other types of memory cells, such as multi-level cells (MLCs), triple level cells (TLCs), and quad-level cells (QLCs), can store multiple bits per cell. In some embodiments, each of the memory devices 130 can include one or more arrays of memory cells such as SLCs, MLCs, TLCs, QLCs, or any combination of such. In some embodiments, a particular memory device can include an SLC portion, and an MLC portion, a TLC portion, or a QLC portion of memory cells. The memory cells of the memory devices 130 can be grouped as pages that can refer to a logical unit of the memory device used to store data. With some types of memory (e.g., NAND), pages can be grouped to form blocks.

Although non-volatile memory components such as a 3D cross-point array of non-volatile memory cells and NAND type flash memory (e.g., 2D NAND, 3D NAND) are described, the memory device 130 can be based on any other type of non-volatile memory, such as read-only memory (ROM), phase change memory (PCM), self-selecting memory, other chalcogenide based memories, ferroelectric transistor random-access memory (FeTRAM), ferroelectric random access memory (FeRAM), magneto random access memory (MRAM), Spin Transfer Torque (STT)-MRAM, conductive bridging RAM (CBRAM), resistive random access memory (RRAM), oxide based RRAM (OxRAM), negative-or (NOR) flash memory, electrically erasable programmable read-only memory (EEPROM).

A memory sub-system controller 115 (or controller 115 for simplicity) can communicate with the memory device(s) 130 to perform operations such as reading data, writing data, or erasing data at the memory devices 130 and other such operations. The memory sub-system controller 115 can include hardware such as one or more integrated circuits and/or discrete components, a buffer memory, or a combination thereof. The hardware can include a digital circuitry with dedicated (i.e., hard-coded) logic to perform the operations described herein. The memory sub-system controller 115 can be a microcontroller, special purpose logic circuitry (e.g., a field programmable gate array (FPGA), an application specific integrated circuit (ASIC), etc.), or other suitable processor.

The memory sub-system controller 115 can include a processor 117 (e.g., a processing device) configured to execute instructions stored in a local memory 119. In the illustrated example, the local memory 119 of the memory sub-system controller 115 includes an embedded memory configured to store instructions for performing various processes, operations, logic flows, and routines that control operation of the memory sub-system 110, including handling communications between the memory sub-system 110 and the host system 120.

In some embodiments, the local memory 119 can include memory registers storing memory pointers, fetched data, etc. The local memory 119 can also include read-only memory (ROM) for storing micro-code. While the example memory sub-system 110 in FIG. 1 has been illustrated as including the memory sub-system controller 115, in another embodiment of the present disclosure, a memory sub-system 110 does not include a memory sub-system controller 115, and can instead rely upon external control (e.g., provided by an external host, or by a processor or controller separate from the memory sub-system).

In general, the memory sub-system controller 115 can receive commands or operations from the host system 120 and can convert the commands or operations into instructions or appropriate commands to achieve the desired access to the memory device(s) 130. The memory sub-system controller 115 can be responsible for other operations such as wear leveling operations, garbage collection operations, error detection and error-correcting code (ECC) operations, encryption operations, caching operations, and address translations between a logical address (e.g., logical block address (LBA), namespace) and a physical address (e.g., physical block address) that are associated with the memory device(s) 130. The memory sub-system controller 115 can further include host interface circuitry to communicate with the host system 120 via the physical host interface. The host interface circuitry can convert the commands received from the host system into command instructions to access the memory device(s) 130 as well as convert responses associated with the memory device(s) 130 into information for the host system 120.

The memory sub-system 110 can also include additional circuitry or components that are not illustrated. In some embodiments, the memory sub-system 110 can include a cache or buffer (e.g., DRAM) and address circuitry (e.g., a row decoder and a column decoder) that can receive an address from the memory sub-system controller 115 and decode the address to access the memory device(s) 130.

In some embodiments, the memory device(s) 130 include local media controllers 135 that operate in conjunction with memory sub-system controller 115 to execute operations on one or more memory cells of the memory device(s) 130. An external controller (e.g., memory sub-system controller 115) can externally manage the memory device 130 (e.g., perform media management operations on the memory device(s) 130). In some embodiments, a memory device 130 is a managed memory device, which is a raw memory device (e.g., memory array 104) having control logic (e.g., local controller 135) for media management within the same memory device package. An example of a managed memory device is a managed NAND (MNAND) device. Memory device(s) 130, for example, can each represent a single die having some control logic (e.g., local media controller 135) embodied thereon. In some embodiments, one or more components of memory sub-system 110 can be omitted.

In one embodiment, the memory sub-system 110 includes a memory interface 113 that is responsible for handling interactions of memory sub-system controller 115 with the memory devices of memory sub-system 110, such as memory device 130 and memory device 140. For example, the memory interface 113 can send memory access commands corresponding to requests received from host system 120 to memory device 130 and memory device 140, such as program commands, read commands, or other commands. In addition, the memory interface 113 can receive data from memory device 130 or memory device 140, such as data retrieved in response to a read command or a confirmation that a program command was successfully performed. In some embodiments, the memory sub-system controller 115 includes at least a portion of the memory interface 113. For example, the memory sub-system controller 115 can include a processor 117 (processing device) configured to execute instructions stored in local memory 119 for performing the operations described herein.

In one embodiment, at least a portion of volatile memory device 140 is configured as a controller memory buffer (CMB) 144. The controller memory buffer 144 can serve as a high-speed data buffer to cache frequently accessed data or instructions for a processing device (e.g., a GPU) of host system 120. In one embodiment, the controller memory buffer 144 is configured to store data logs relating to the firmware of the memory sub-system, including input/output (I/O) data (I/O data logs) associated with the memory sub-system 110 that can be used to debug I/O issues. In one embodiment, the controller memory buffer 144 provides a directly addressable memory space for host system 120 to read the I/O data logs for use in one or more debugging operations or processes. Further details with regard to the use of the controller memory buffer 144 are described below.

In an embodiment, the memory sub-system controller 110 includes a log manager 134 that can be used to manage the recording or storing of I/O data logs to a memory sub-system controller memory buffer (herein the “controller buffer memory” or “CMB”) 144 of a memory device 140. In an embodiment, the log manager 134 includes processing logic to write runtime I/O data logs to a designated portion (e.g., one or more designated blocks) of the CMB. In an embodiment, the log manager 134 can determine that one or more I/O data logs stored in a designated block of the CMB has been read (e.g., read by a debug computing system, as described in greater detail below), indicating to the log manager 134 that the designated block is available to be rewritten with new I/O log data.

According to embodiments, the controller memory buffer 144 includes a set of designated blocks (e.g., memory area portions) designated or allocated to store or record I/O data logs written by the log manager 134. According to embodiments, the controller memory buffer 144 is accessible by a computing system (e.g., a secondary computing system configured to perform one or more debugging processes based on the I/O data logs stored in the controller memory buffer 144). In an embodiment, the designated blocks of the controller memory buffer 144 are directly accessible via an interface (e.g., a PCEi interface) by a computing system (e.g., host system 120 of FIG. 1) (herein referred to as the “debug computing system”) to read the I/O data logs stored in the set of designated blocks of the controller memory buffer, as described in greater detail below.

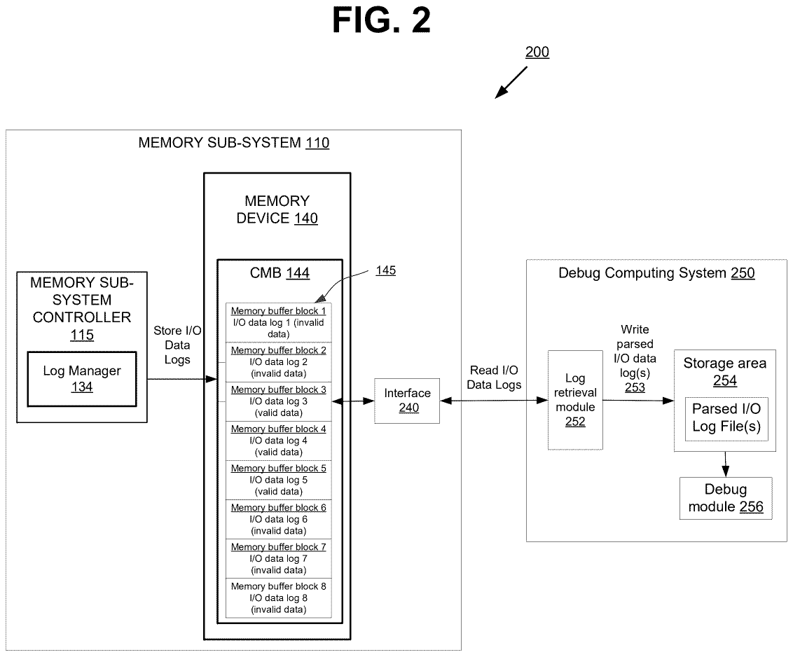

FIG. 2 is a block diagram illustrating a system 200 including a memory sub-system 110 including a memory sub-system controller 115 having a log manager 134 configured to manage a controller memory buffer 144 of a memory device 140. As shown in FIG. 2, the system 200 includes a computing system (debug computing system 250) configured to access the controller memory buffer 144 via an interface 240 (e.g., a host interface) to read one or more I/O data logs stored in the controller memory buffer 144.

As illustrated in FIG. 2, the controller memory buffer 144 includes a set of memory buffer blocks 145 configured to store I/O data logs written by the log manager 134. According to embodiments, the log manager 134 manages and maintains a pointer (also referred to as a “first pointer” or “write pointer”) to identify which memory buffer block of the set of memory buffer blocks 145 to store a next incremental portion of I/O data logs. For example, at a first time, using the first pointer, the log manager 134 may identify that memory buffer block 1 is the next memory buffer block to be written to with one or more I/O data logs. At the first time, the log manager 134 may write I/O data log 1 to memory buffer block 1. At a second time, using the first pointer, the log manager 134 may identify that memory buffer block 2 is the next memory buffer block to be written to with one or more I/O data logs. The log manager 134 can use the first pointer to manage the controller memory buffer 144 in a cyclical manner. In an embodiment, each memory buffer block of the set of memory buffer blocks 145 (e.g., memory buffer block 1 through memory buffer block 8) is configured to store the I/O data log(s) for a threshold storage time period. The threshold storage time period is a period of time or duration that a memory buffer block can store one or more I/O data logs without being overwritten. In an embodiment, at the expiration of the threshold storage time period associated with a memory buffer block storing I/O data log(s), the log manager 134 can write new I/O data log(s) to that memory buffer block.

According to embodiments, each I/O data log entry stored in the memory buffer blocks of the controller memory buffer 144 has an associated flag or other indicator that is set to a value of either “invalid” or “valid”. In an embodiment, each flag is initialized to an “invalid” value. When storing a new or valid I/O data log, the log manager 134 uses the first pointer and identifies a first invalid I/O data log entry (i.e., a first I/O data log entry in the sequence that has a flag indicating the I/O data log entry is invalid). Upon identifying the first invalid I/O data log entry, the log manager 134 saves the valid I/O data log to the corresponding portion of the memory buffer block of the identified invalid I/O data log entry, and sets the flag for the newly saved valid I/O data log to “valid”. The log manager 134 can then move to a next invalid I/O data log entry to store a next new or valid I/O data log.

According to embodiments, the debug computing system 250 (e.g., host system 120 of FIG. 1) includes a log retrieval module 252 configured to read the I/O log data in the controller memory buffer 144 through the interface 240. In an embodiment, the I/O log data retrieved by the log retrieval module 252 can be encoded in a first format. In an embodiment, the log retrieval module 252 can read the one or more I/O data logs and parse (e.g., decode) the log data using one or more parsing processes. The parsed I/O data logs can be written by the log retrieval module 252 to a storage area 254 where one or more parsed I/O log files can be stored. As illustrated in FIG. 2, the debug computing system 250 can include processing logic (e.g., debug module 256) configured to execute one or more debug processes using the parsed I/O log file(s).

According to embodiments, the log retrieval module 252 can be configured to read and parse the I/O data logs stored in the controller memory buffer 144 on a periodic basis (e.g., at an established interval, also referred to as the “retrieval interval”). According to embodiments, following the retrieval of I/O data logs from one or more blocks of the controller memory buffer 144, those blocks are freed up or made available to be rewritten to by the log manager 134 with new I/O data logs. According to embodiments, the retrieval interval can be set or tuned to set a desired or target frequency of the reading of the I/O data logs from one or more blocks or portions of the controller memory buffer 144 to optimize the amount of I/O data that can be captured and used for debugging purposes. In addition, the cyclical storing of I/O data to a block of the controller memory buffer 144, reading of the stored I/O data logs from the controller memory buffer 144 by the debug computing system 250, and rewriting of new I/O data logs to the block of the controller memory buffer 144 enables a maximum amount of I/O data logs to be saved and used for debugging purposes.

According to embodiments, the interface 240 (e.g., a PCEi interface) enables communication between the controller memory buffer 144 of the memory sub-system 110 and the debug computing system 250 (e.g., via a network connection) to enable the reading of the I/O data. In an embodiment, the controller memory buffer 144 is accessible by the debug computing system 250 via the interface 240 using an NVM Express (NVMe) communication protocol which supports direct memory access (DMA) data transfers associated with the I/O data logs.

According to embodiments, the controller memory buffer 144 is configured to be read incrementally by the debug computing system 250, where the debug computing system 250 reads “new” I/O data logs (e.g., I/O data logs including valid data), avoiding the repeated reading of previously read I/O data logs. In the example shown in FIG. 2, at the start of a new retrieval interval, the log retrieval module 252 of the debug computing system 250 can access the controller memory buffer 144 via the interface 240 to read or retrieve I/O data logs from one or more memory buffer blocks.

According to embodiments, the log retrieval module 252 of the debug computing system 250 maintains a pointer (also referred to as a “second pointer” or “read pointer”) to indicate and identify a next memory buffer block to read during a next retrieval operation associated with the controller memory buffer 144. In an embodiment, during a retrieval operation, the log retrieval module 252 accesses the control buffer memory 144 and uses the second pointer (i.e., the read pointer maintained by the log retrieval module 252) to identify a next memory buffer block (e.g., memory buffer block 1 through 8) to read. In an embodiment, the read pointer can be used to cyclically read the control memory buffer 144 in a manner that memory buffer blocks storing new or valid I/O data logs are read, while avoiding reading memory buffer blocks that have been overwritten (e.g., store invalid I/O data logs) by the log manager 134.

According to embodiments, the log retrieval module 252 accesses the set of one or more memory buffer blocks in a sequence according to the second pointer (i.e., the read pointer), starting with a first memory buffer block storing one or more I/O data logs including valid data. In the example shown in FIG. 2, the retrieval processing executed by the log retrieval module 252 includes using the read pointer to access the set of memory buffer blocks in the following sequence: memory buffer block 3, followed by memory buffer block 4, followed by memory buffer block 5. According to an embodiment, in accordance with a current value of the read pointer indicating that memory buffer block 3 is the next memory buffer block to be read, the retrieval processing skips accessing memory buffer blocks 1 and 2, since those memory buffer blocks store I/O data logs having invalid data. Advantageously, the incremental and cyclical retrieval processing enables the debug computing system 250 to perform a targeted reading of new or valid log data in a cyclical manner.

According to embodiments, the retrieval interval (used by the log retrieval module 252 during the reading of the controller memory buffer 144) is less than the threshold storage time period (i.e., the period of time or duration that a memory buffer block is store one or more I/O data logs without being overwritten), to ensure that I/O data logs are read by the debug computing system 250 prior to the expiration of the threshold storage time period so that the stored valid I/O data logs are captured and retrieved for use by the debug computing system 250.

According to embodiments, the debug log retrieval module 252 finds a first valid entry using the corresponding flag, parses the data of the I/O data log inside the identified entry, and then sets the flag status of the identified entry to invalid. In an embodiment, the debug log retrieval module 252 moves to a next valid I/O data log entry (as identified by the corresponding flag) to perform a next retrieval operation.

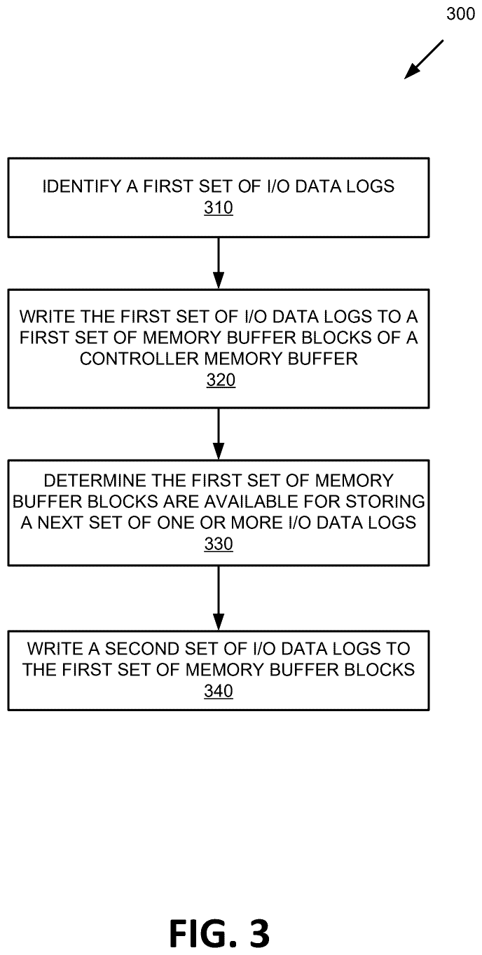

FIG. 3 is a flow diagram of an example method of recording one or more I/O data logs using a memory sub-system controller memory buffer, in accordance with one or more embodiments of the present disclosure. The method 300 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 300 is performed by a log manager 134 of FIG. 1. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 310, the processing logic (e.g., log manager 134) identifies a first set of I/O data logs associated with one or more I/O activities of a memory sub-system (e.g., memory sub-system 110 of FIGS. 1 and 2). In an embodiment, the I/O data logs relate to I/O activities associated with the transferring (i.e., input and output) of data to and from the memory devices (e.g., memory devices 130, 140 of FIG. 1).

In an embodiment, the processing logic can identify each I/O data log of the first set of I/O data logs using a flag associated with each of the I/O data log entries. In an embodiment, the processing logic identifies an I/O data log entry having an “invalid” flag.

At operation 320, the processing logic writes the first set of I/O data logs to a first set of memory buffer blocks of a controller memory buffer (e.g., controller memory buffer 144 of the memory sub-system 110 of FIGS. 1 and 2). In an embodiment, the controller memory buffer includes a set of memory buffer blocks, each designated to store I/O data logs written by the processing logic. In an embodiment, the processing logic can write or store a first subset of the first set of I/O data logs to a first memory buffer block, a second subset of the first set of I/O data logs to a second memory buffer block, and so on until all of the first set of I/O data logs are stored in the controller memory buffer. In an embodiment, each memory buffer block can be configured to store I/O data log(s) for a threshold storage time period. In an embodiment, at the expiration or end of a threshold storage time period associating with a previous writing of I/O data, the processing logic can initiate the writing of the next set of I/O data logs (e.g., the first set of I/O data logs) at operation 320. For example, the first set of memory buffer blocks can include memory buffer blocks 1 and 2 of FIG. 2. In an embodiment, the processing logic can encode or encrypt the I/O data logs stored in the controller memory buffer.

In an embodiment, the processing logic writes the valid I/O data to portion of the controller memory buffer corresponding to an identified “invalid” I/O data log entry (i.e., identified as having an “invalid” flag in operation 310. Having identified the “invalid” I/O data log entry, the processing logic can write the new or valid data to the identified I/O data log entry, and set the flag to “valid”. In an embodiment, the processing logic can move to a next “invalid” I/O data log entry to write a next valid I/O data log.

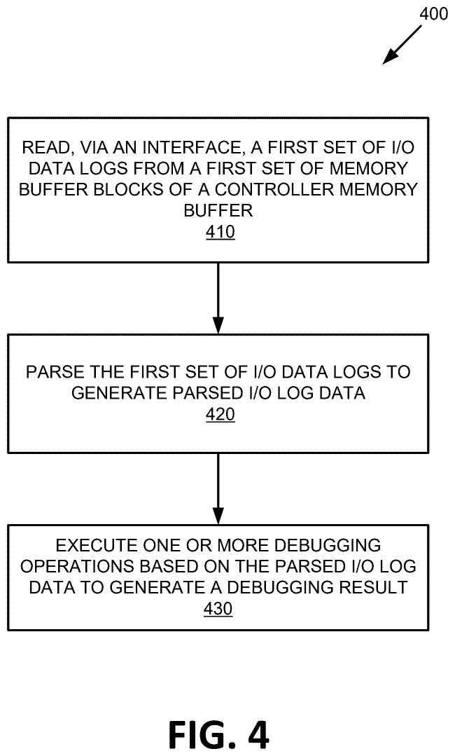

At operation 330, the processing logic determines the first set of memory buffer blocks are available for storing a new set of I/O data logs. In an embodiment, the processing logic can determine that the first set of memory buffer blocks (written to in operation 320) have been read by a computing system (e.g., debug computing system 250 of FIG. 2), as described in greater detail with reference to FIGS. 2 and 4. In an embodiment, the processing logic can identify an indication that a retrieval or reading operation has been executed and the first set of I/O data logs have been read from the first set of memory buffer blocks by the computing system. In an embodiment, the processing logic can determine that the threshold storage period associated with the first set of memory buffer blocks has expired, indicating that those memory buffer blocks are available to store a next or new set of I/O data logs (e.g., a second set of I/O logs, in the example shown in FIG. 3).

At operation 340, the processing logic writes a second set of I/O data logs to the first set of memory buffer blocks of the controller memory buffer. In an embodiment, the second set of I/O data logs includes a new set of valid I/O data identified in a period since the execution of operation 320. Advantageously, the first set of memory buffer blocks can be re-used and rewritten to by the processing logic, to optimize the use of the storage of the controller memory buffer. In an embodiment, the processing logic writes the second set of I/O data logs after the first set of I/O data logs have been read and retrieved by another computing system (e.g., debug computing system 250 of FIG. 2) from the first set of memory buffer blocks, as described below with reference to FIG. 4. Accordingly, the processing logic manages the cyclical storing of I/O data logs to the controller memory buffer in a manner with both optimized the available storage space of the controller memory buffer and maximizes an amount of I/O data that can be retrieved and used for debugging purposes.

FIG. 4 is a flow diagram of an example method of accessing a controller memory buffer to read data logs for use in executing a debugging process, in accordance with one or more embodiments of the present disclosure. The method 400 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 400 is performed by processing logic of debug computing system 250 of FIG. 2. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 410, the processing logic of the debug computing system (e.g., a server communicatively coupled to the memory sub-system 110) reads, via an interface (e.g., a host interface such as interface 240 of FIG. 2), a first set of I/O data logs from a first set of memory buffer blocks of a controller memory buffer of a memory sub-system. In an embodiment, the processing logic of the debug computing system (e.g., log retrieval module 252 of FIG. 2) can initiate the reading of the first set of memory buffer blocks following the expiration of a previous retrieval interval (e.g., a time period since the last retrieval operation). According to embodiments, at the beginning of each retrieval interval, the processing logic can access the controller memory buffer to identify and retrieve one or more I/O data logs from one or more controller memory blocks. In an embodiment, in the retrieval operation, the processing logic can identify a first memory buffer block of the set of memory buffer blocks of the controller memory buffer that includes valid or new I/O data. The retrieval operation can further include accessing a sequence of memory buffer blocks to access and read the first set of I/O data logs.

According to embodiments, at operation 410, the first set of I/O data logs includes only I/O data logs including valid data (e.g., valid I/O data log entries). For example, with reference to FIG. 2, at operation 410, the processing logic reads memory buffer block 3, memory buffer block 4, and memory buffer block 5 which store I/O data logs including valid data (e.g., I/O data log 3, I/O data log 4, and I/O data log 5). According to embodiments, the processing logic can identify a first valid entry of the first set of I/O data logs based on the corresponding flag or indicator that the I/O data log entry is valid. The processing logic continues to go through the I/O data logs to identify the valid I/O data logs that make up the first set of I/O data logs.

At operation 420, the processing logic of the debug computing system parses the first set of I/O data logs to generate parsed I/O log data. In an embodiment, the processing logic (e.g., log retrieval module 252) parses the retrieved first set of I/O data logs (e.g., using one or more Python scripts) and stores the parsed I/O log data in a storage area of the debug computing system (e.g., storage area 254 of FIG. 2). In an embodiment, the parsing operation may include decoding the first set of I/O data logs when those logs are encoded or encrypted. In an embodiment, the log retrieval module 252 can parse the first set of data logs and store the parsed I/O data in one or more files (e.g., parsed I/O log file(s) of FIG. 2), such as, for example, Microsoft® Excel ® files. In an embodiment, the parsed I/O log files can be stored in chronological order to enable fast and efficient use of the files in a subsequent debugging process. In an embodiment, following completion of the parsing operation (operation 420), the first set of I/O data logs can be designated as “invalid”, and the corresponding memory buffer blocks (e.g., memory buffer block 3, memory buffer block 4, and memory buffer block 5 in the example shown in FIG. 2) are available for re-use (e.g., the storing of a new set of valid I/O data logs) by the log manager (e.g., log manager 134 of FIG. 2).

According to an embodiment, after parsing each I/O data log, the processing logic sets the flag corresponding to the read and parsed I/O data log to “invalid”, then proceeds to identify a next valid I/O data log to read and parse.

At operation 430, the processing logic of the debug computing system executes one or more debugging operations based on the parsed I/O log data to generate a debugging result. In an embodiment, the one or more debugging operations can be part of a debugging process executed by processing logic (e.g., debug module 256) of the debug computing system. Advantageously, the parsed I/O log files can be generated as a result of the iterative execution of operations the method 400, where each read of the controller memory buffer (operation 410) retrieves an incremental portion of the I/O data logs (e.g., the first set of I/O data logs, following by a second set of I/O data logs, and so on).

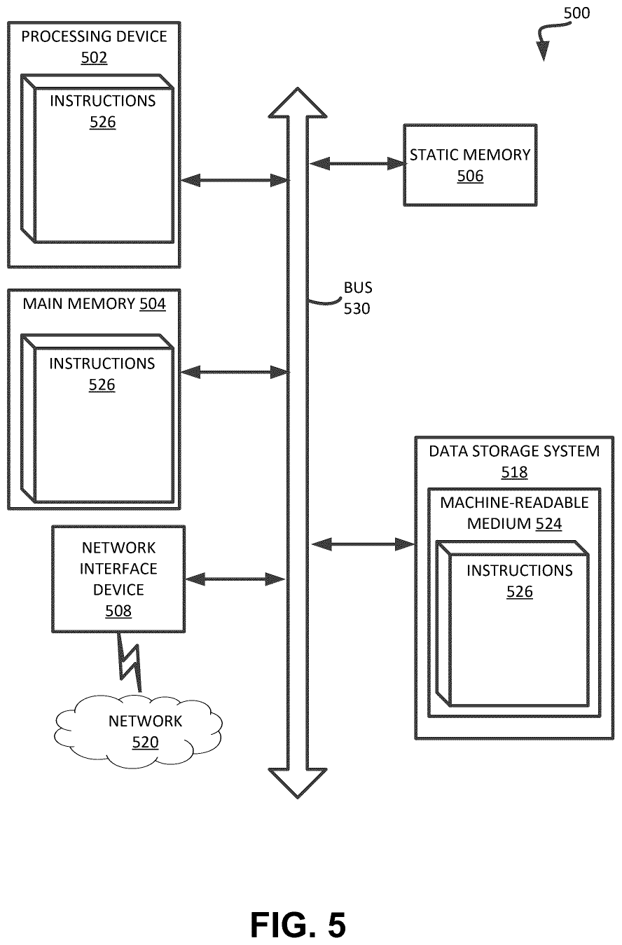

FIG. 5 illustrates an example machine of a computer system 500 within which a set of instructions, for causing the machine to perform any one or more of the methodologies discussed herein, can be executed. In some embodiments, the computer system 500 can correspond to a host system (e.g., the host system 120 of FIG. 1) that includes, is coupled to, or utilizes a memory sub-system (e.g., the memory sub-system 110 of FIG. 1) or can be used to perform the operations of a controller (e.g., to execute an operating system to perform operations corresponding to the memory interface 113 or memory sub-system controller 115 of FIG. 1). In alternative embodiments, the machine can be connected (e.g., networked) to other machines in a LAN, an intranet, an extranet, and/or the Internet. The machine can operate in the capacity of a server or a client machine in client-server network environment, as a peer machine in a peer-to-peer (or distributed) network environment, or as a server or a client machine in a cloud computing infrastructure or environment.

The machine can be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 500 includes a processing device 502, a main memory 504 (e.g., read-only memory (ROM), flash memory, dynamic random access memory (DRAM) such as synchronous DRAM (SDRAM) or Rambus DRAM (RDRAM), etc.), a static memory 506 (e.g., flash memory, static random access memory (SRAM), etc.), and a data storage system 518, which communicate with each other via a bus 530.

Processing device 502 represents one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 502 can also be one or more special-purpose processing devices such as an application specific integrated circuit (ASIC), a field programmable gate array (FPGA), a digital signal processor (DSP), network processor, or the like. The processing device 502 is configured to execute instructions 526 for performing the operations and steps discussed herein. The computer system 500 can further include a network interface device 508 to communicate over the network 520.

The data storage system 518 can include a machine-readable storage medium 524 (also known as a computer-readable medium) on which is stored one or more sets of instructions 526 or software embodying any one or more of the methodologies or functions described herein. The instructions 526 can also reside, completely or at least partially, within the main memory 504 and/or within the processing device 502 during execution thereof by the computer system 500, the main memory 504 and the processing device 502 also constituting machine-readable storage media. The machine-readable storage medium 524, data storage system 518, and/or main memory 504 can correspond to the memory sub-system 110 of FIG. 1.

In one embodiment, the instructions 526 include instructions to implement functionality corresponding to the log manager 134 of the memory sub-system 110 of FIG. 1 and/or functionality corresponding to the debug computing system 250 of FIG. 2. While the machine-readable storage medium 524 is shown in an example embodiment to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general purpose computer selectively activated or reconfigured by a computer program stored in the computer. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory components, etc.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

What is claimed is:

1. A system comprising:
a non-volatile memory device;
a volatile memory device comprising a first portion configured as a controller memory buffer;
a host interface; and
a processing device, operatively coupled to the host interface, the non-volatile memory device, and the volatile memory device, to perform operations comprising:
identifying a first set of input/output (I/O) data logs, wherein the first set of I/O data logs comprises first data associated with one or more input/output activities of the non-volatile memory device occurring in a first time period; and
writing the first set of I/O data logs to a first set of memory buffer blocks of the controller memory buffer, wherein the controller memory buffer is accessible via the host interface.

2. The system of claim 1, the operations further comprising:
determining the first set of memory buffer blocks are available for storing a second set of I/O data logs; and
writing the second set of I/O data logs to the first set of memory buffer blocks of the controller memory buffer.

3. The system of claim 2, wherein the processing device uses a pointer to determine that the first set of memory buffer blocks are available for the writing of the first set of I/O data logs.

4. The system of claim 2, wherein the processing device determines that a threshold storage time period associated with the first set of memory buffer blocks has expired.

5. The system of claim 4, wherein the controller memory buffer is accessed by a computing system at a retrieval interval.

6. The system of claim 5, wherein the retrieval interval is less than the threshold storage time period.

7. The system of claim 2, wherein the first set of I/O data logs comprises first data associated with one or more input/output activities of the non-volatile memory device occurring in a first time period; and wherein the second set of I/O data logs comprises second data associated with one or more I/O activities of the non-volatile memory device occurring in a second time period.

8. The system of claim 1, the operations further comprising encrypting the first set of I/O data logs written to the first set of memory buffer blocks.

9. The system of claim 1, wherein the interface comprises an NVM Express interface supporting direct memory access (DMA) data transfers from the controller memory buffer.

10. The system of claim 1, wherein the first set of I/O data logs are used during execution of a debugging process associated with the non-volatile memory device.

11. A system comprising:
a memory sub-system comprising:
a volatile memory device comprising a first portion configured as a controller memory buffer;
an interface operatively coupled to the controller memory buffer; and
one or more first processing devices, operatively coupled to the volatile memory device, to perform first operations comprising writing, at a first time, a first set of I/O data logs to a first set of memory buffer blocks of the controller memory buffer, wherein the first set of I/O data logs comprises first data associated with one or more input/output activities occurring in a first time period; and
a computing system comprising one or more second processing devices to perform second operations comprising:
accessing the controller memory buffer via the interface; and
reading, at a second time, the first set of I/O data logs from the first set of memory buffer blocks of the controller memory buffer.

12. The system of claim 11, wherein the first operations further comprise:
determining the first set of memory buffer blocks are available for storing a second set of I/O data logs; and
writing, at a third time, the second set of I/O data logs to the first set of memory buffer blocks of the controller memory buffer.

13. The system of claim 12, wherein the one or more first processing devices use a first pointer to determine that the first set of memory buffer blocks are available for the writing of the first set of I/O data logs.

14. The system of claim 13, wherein the controller memory buffer is accessed by the computing system at a retrieval interval.

15. The system of claim 14, wherein the one or more second processing devices use a second pointer to identify the first set of memory buffer blocks are to be read at the second time.

16. A method comprising:
identifying, by a processing device, a first set of input/output (I/O) data logs associated with one or more non-volatile memory devices of a memory sub-system, wherein the first set of I/O data logs comprises first data associated with one or more input/output activities of the one or more non-volatile memory devices occurring in a first time period; and
writing the first set of I/O data logs to a first set of memory buffer blocks of a controller memory buffer of a volatile memory device of the memory sub-system, wherein the controller memory buffer is accessible via an interface.

17. The method of claim 16, further comprising:
determining the first set of memory buffer blocks are available for storing a second set of I/O data logs; and
writing the second set of I/O data logs to the first set of memory buffer blocks of the controller memory buffer.

18. The method of claim 17, wherein the processing device determines the first set of memory buffer blocks are available using a pointer.

19. The method of claim 17, wherein the processing device determines the first set of memory buffer blocks are available based on identifying an expiration of a threshold storage time period associated with the first set of memory buffer blocks.

20. The method of claim 19, further comprising encrypting the first set of I/O data logs written to the first set of memory buffer blocks.
